(19) United States
(12) Patent Application Publication
(10) Pub. No.: US 2024/0405927 A1
(43) Pub. Date: Dec. 5, 2024

(54) HARQ-ACK BASED PDSCH TRANSMISSION SCHEDULED BY MULTIPLE DL ASSIGNMENTS

(71) Applicant: Intel Corporation, Santa Clara, CA (US)

(72) Inventors: Yi Wang, Beijing (CN); Gang Xiong, Beaverton, OR (US); Dae Won Lee, Portland, OR (US); Yingyang Li, Beijing (CN)

(21) Appl. No.: 18/723,781

(22) PCT Filed: Feb. 15, 2023
(86) PCT No.: PCT/US2023/013105

§ 371 Date: Jun. 24, 2024

Related U.S. Application Data
(60) Provisional application No. 63/333,462, filed on Apr. 21, 2022.
(60) Provisional application No. 63/315,366, filed on Mar. 1, 2022.
(60) Provisional application No. 63/314,932, filed on Feb. 28, 2022.
(60) Provisional application No. 63/311,816, filed on Feb. 18, 2022.

(51) Int. Cl. H04L 1/1829; H04L 1/1812; H04L 5/00; H04W 72/1273

(52) U.S. Cl. CPC H04L 1/1854; H04L 1/1816; H04L 1/1858; H04L 5/0055; H04W 72/1273

(57) ABSTRACT

A user equipment (UE) may generate first HARQ-ACK information bits based on a first PDSCH and second HARQ-ACK information bits based on a second PDSCH. The UE may determine a first slot for an expected PUCCH transmission with the first HARQ-ACK information bits. When the UE is configured for deferring HARQ-ACK for the first PDSCH and when the first slot is unavailable for the expected PUCCH transmission, the UE may determine an earliest second slot that is available. The UE may also determine a third slot for an expected PUCCH transmission with the second HARQ-ACK information bits assigned for the second PDSCH. The resource assigned for transmission of the first HARQ-ACK information bits is used to verify the order for the first and second HARQ-ACK transmissions regardless of whether the first slot is unavailable and the second earliest slot is used for transmission of the first HARQ-ACK information bits.

### PRIORITY CLAIM

This application claims the benefit of priority to U.S. Provisional Patent Application Ser. No. 63/311,816, filed Feb. 18, 2022 [reference number AE2049-Z], U.S. Provisional Patent Application Ser. No. 63/314,932, filed Feb. 28, 2022 [reference number AE2202-Z], U.S. Provisional Patent Application Ser. No. 63/315,366, filed Mar. 1, 2022 [reference number AE2224-Z], U.S. Provisional Patent Application Ser. No. 63/333,462, filed Apr. 21, 2022 [reference number AE3184-Z], which are incorporated herein by reference in their entireties.

### TECHNICAL FIELD

Embodiments pertain to wireless communications. Some embodiments relate to wireless networks including 3GPP (Third Generation Partnership Project) and fifth-generation (5G) networks including 5G new radio (NR) (or 5G-NR) networks. Some embodiments relate to sixth-generation (6G) networks.

### BACKGROUND

Mobile communications have evolved significantly from early voice systems to today's highly sophisticated integrated communication platform. With the increase in different types of devices communicating with various network devices, usage of 3GPP 5G NR systems has increased. The penetration of mobile devices (user equipment or UEs) in modern society has continued to drive demand for a wide variety of networked devices in many disparate environments. 5G NR wireless systems are forthcoming and are expected to enable even greater speed, connectivity, and usability, and are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

One issue with in a 5G NR network are the order of HARQ-ACK based PDSCH transmissions scheduled by multiple DL assignments. This is particularly an issue for PDSCHs configured for downlink semi-persistent scheduling (SPS) when the UE is configured for deferring HARQ-ACK for a PDSCH.

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIG. 2 illustrates a functional block diagram of a wireless communication device, in accordance with some embodiments.

FIG. 3 illustrates multi-TTI scheduling for PDSCHs, in accordance with some embodiments.

FIG. 4 illustrates out-of-order (OOO) checking based on the first indicated PUCCH repetition, in accordance with some embodiments.

FIG. 5 illustrates OOO checking based on the first indicated PUCCH repetition, in accordance with some embodiments.

FIG. 6 illustrates OOO checking based on all available PUCCH repetitions, in accordance with some embodiments.

FIG. 7 illustrates OOO checking based on indicated PUCCH, in accordance with some embodiments.

FIG. 8 illustrates OOO checking based on the indicated PUCCH, in accordance with some embodiments.

FIG. 9 illustrates encoding HARQ-ACK and CSI on PUSCH in case of missing DL grant for PUSCH, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In some embodiments, a user equipment (UE) configured for operation in a 5G NR network may decode a first PDSCH and a second PDSCH and may generate first HARQ-ACK information bits based on the first PDSCH and second HARQ-ACK information bits based on the second PDSCH. When the UE is configured for deferring HARQ-ACK for the first PDSCH, the UE may determine a first slot for an expected PUCCH transmission with the first HARQ-ACK information bits. When the first slot is unavailable for the expected PUCCH transmission of the first HARQ-ACK information bits, the UE may determine an earliest second slot that is available for a PUCCH transmission that includes the first HARQ-ACK information bits. The UE may also determine a third slot for an expected PUCCH transmission with the second HARQ-ACK information bits, assigned for the second PDSCH. The UE may also verify for the scheduled cell, when the second PDSCH starts later than the first PDSCH, that a resource assigned by the second feedback timing for transmission of the second HARQ-ACK information bits does not end before a start of a resource assigned for transmission of the first HARQ-ACK information bits. In these embodiments, the resource assigned for transmission of the first HARQ-ACK information bits is always used to verify the order for the first and second HARQ-ACK transmissions even when the first slot is unavailable and the second earliest slot is used for transmission of the first HARQ-ACK information bits. These embodiments, as well as others, are described in more detail below.

In some embodiments, when a UE is scheduled by a gNB for transmission of multiple PUSCHs on respective serving cells and the multiple PUSCHs overlap with a PUCCH carrying uplink control information (UCI) in a slot, the UE may select the PUSCHs that are overlapping with the PUCCH carrying the UCI as candidate PUSCHs for UCI multiplexing in the slot. In these embodiments, when at least one of the multiple PUSCHs is scheduled by a DCI format that includes a downlink assignment index (DAI) field, for HARQ-ACK multiplexing, the UE may be configured to exclude one or more of the candidate PUSCHs for HARQ-ACK multiplexing that are scheduled by a DCI format that includes a DAI field that is equal to four or equal to zero when no PUCCH carrying HARQ-ACK information bits is determined for the slot. In these embodiments, the UE may select one or more of the remaining candidate PUSCHs that have not been excluded for HARQ-ACK multiplexing. These embodiments, as well as others, are described in more detail below.

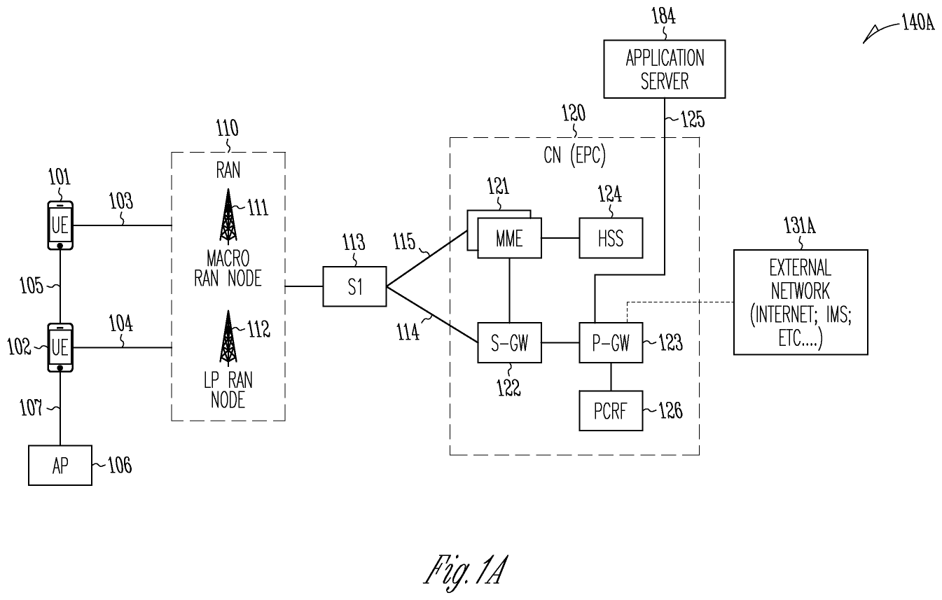

FIG. 1A illustrates an architecture of a network in accordance with some embodiments. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHz, and further frequencies and Spectrum Access System (SAS) in 3.55-3.7 GHZ and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UEs 101 and 102 can comprise an Internet-of-Things (IoT) UE or a Cellular IoT (CIoT) UE, which can comprise a network access layer designed for low-power IoT applications utilizing short-lived UE connections. In some embodiments, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NG-C interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that targets to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people's lives with better, simple, and seamless wireless connectivity solutions. NR will enable everything connected by wireless and deliver fast, rich content and services.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

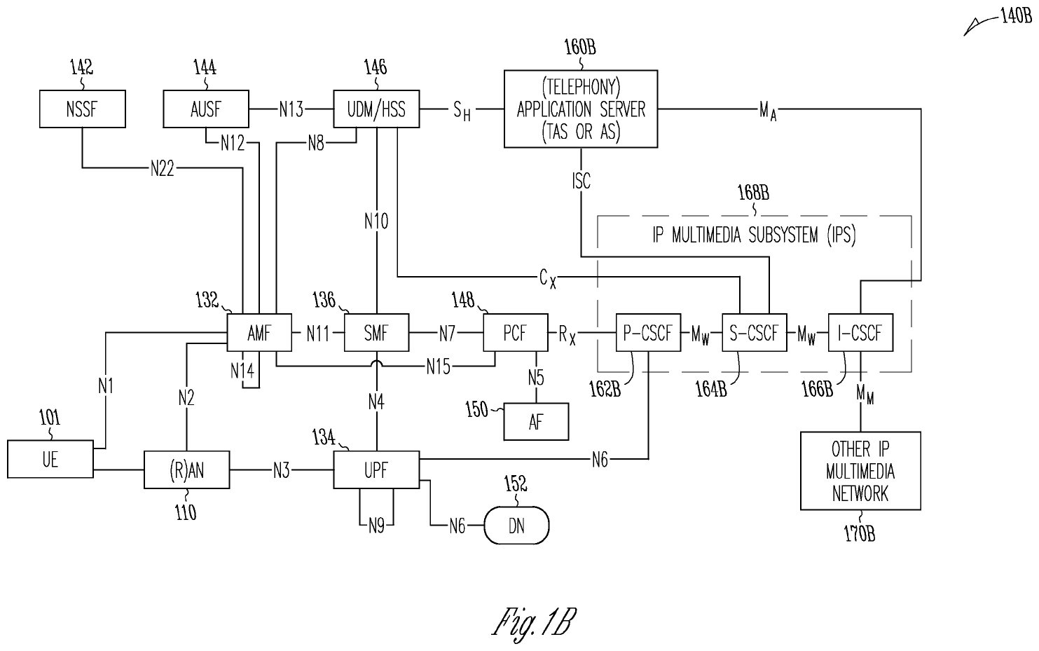

FIG. 2 illustrates a functional block diagram of a wireless communication device, in accordance with some embodiments. Wireless communication device 200 may be suitable for use as a UE or gNB configured for operation in a 5G NR network.

In one embodiment, FIG. 2 illustrates a functional block diagram of a communication device (STA) that may be suitable for use as an AP STA, a non-AP STA or other user device in accordance with some embodiments. The communication device 200 may also be suitable for use as a handheld device, a mobile device, a cellular telephone, a smartphone, a tablet, a netbook, a wireless terminal, a laptop computer, a wearable computer device, a femtocell, a high data rate (HDR) subscriber device, an access point, an access terminal, or other personal communication system (PCS) device.

The communication device 200 may include communications circuitry 202 and a transceiver 210 for transmitting and receiving signals to and from other communication devices using one or more antennas 201. The communications circuitry 202 may include circuitry that can operate the physical layer (PHY) communications and/or medium access control (MAC) communications for controlling access to the wireless medium, and/or any other communications layers for transmitting and receiving signals. The communication device 200 may also include processing circuitry 206 and memory 208 arranged to perform the operations described herein. In some embodiments, the communications circuitry 202 and the processing circuitry 206 may be configured to perform operations detailed in the above figures, diagrams, and flows.

In accordance with some embodiments, the communications circuitry 202 may be arranged to contend for a wireless medium and configure frames or packets for communicating over the wireless medium. The communications circuitry 202 may be arranged to transmit and receive signals. The communications circuitry 202 may also include circuitry for modulation/demodulation, upconversion/downconversion, filtering, amplification, etc. In some embodiments, the processing circuitry 206 of the communication device 200 may include one or more processors. In other embodiments, two or more antennas 201 may be coupled to the communications circuitry 202 arranged for sending and receiving signals. The memory 208 may store information for configuring the processing circuitry 206 to perform operations for configuring and transmitting message frames and performing the various operations described herein. The memory 208 may include any type of memory, including non-transitory memory, for storing information in a form readable by a machine (e.g., a computer). For example, the memory 208 may include a computer-readable storage device, read-only memory (ROM), random-access memory (RAM), magnetic disk storage media, optical storage media, flash-memory devices and other storage devices and media.

In some embodiments, the communication device 200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication device 200 may include one or more antennas 201. The antennas 201 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the communication device 200 may include one or more of a keyboard, a display, a non-volatile memory port, multiple antennas, a graphics processor, an application processor, speakers, and other mobile device elements. The display may be an LCD screen including a touch screen.

Although the communication device 200 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication device 200 may refer to one or more processes operating on one or more processing elements.

In NR, PDSCH transmission based on hybrid automatic retransmission request (HARQ) is adopted. In general, a physical downlink control channel (PDCCH) with downlink control information (DCI) can schedule a physical downlink shared channel (PDSCH). Then HARQ acknowledgment (HARQ-ACK) information can be transmitted in the PUCCH indicated by the PDCCH.

PDSCH repetition is supported in NR. That is, N PDSCHs can be indicated to carry the same TB. For PDSCH repetition type A, the N PDSCH repetitions are in N consecutive slots. For PDSCH repetition type B, the N PDSCH repetitions occupies N consecutive PDSCHs. A PDSCH repetition is dropped if it overlaps with a UL symbol indicated by tdd-UL-DL-ConfigurationCommon or tdd-UL-DL-ConfigurationDedicated. Further, the PDSCH repetition is enhanced so that a PDSCH repetition can be postpone to a next slot if the PDSCH repetition collides with a UL symbol indicated by tdd-UL-DL-ConfigurationCommon or tdd-UL-DL-ConfigurationDedicated for PDSCH repetition Type A.

PUCCH repetition is also supported in NR. Assuming N repetitions are configured for PUCCH, UE should transmit N PUCCH repetitions. It is clarified that a PUCCH repetition in case N>1 (including the first PUCCH repetition) is postponed to the next available slot if the PUCCH repetition collides with SSB symbols or symbols indicated as DL by tdd-UL-DL-ConfigurationCommon or tdd-UL-DL-ConfigurationDedicated.

In NR, it is also supported to defer a PUCCH carrying HARQ-ACK when PUCCH repetition is not configured. Specifically, if the indicated PUCCH by the DL assignment collides with a SSB symbol or a UL symbol indicated by tdd-UL-DL-ConfigurationCommon or tdd-UL-DL-ConfigurationDedicated, the PUCCH can be postponed to a next available slot.

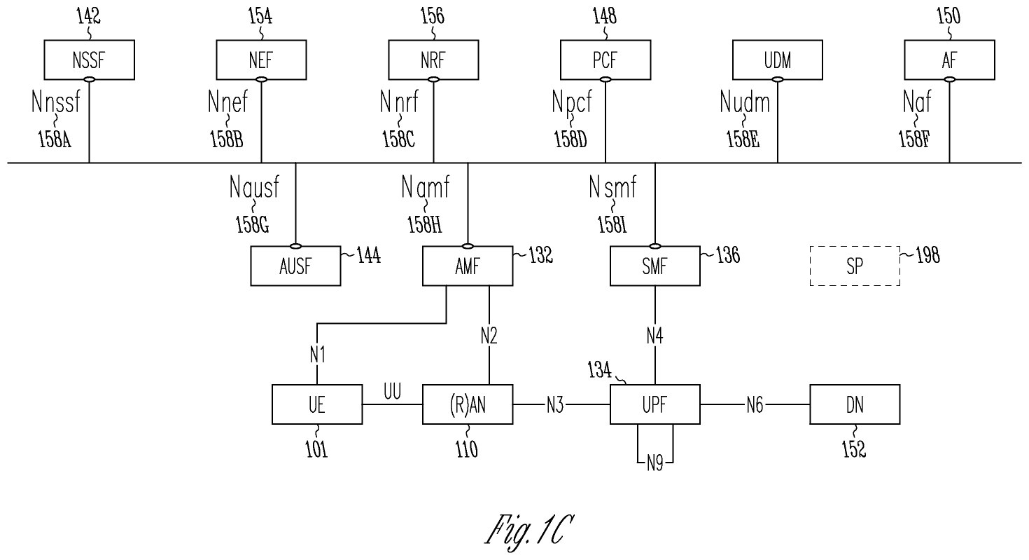

For system operating above 52.6 GHz carrier frequency, the subcarrier spacing, is increased and the slot duration is reduced. A DCI may schedule PDSCH transmissions with one or multiple TBs. FIG. 3 illustrates one example of multi-PDSCH scheduling. In the example, 4 PDSCHs (PDSCH #0-3) with different transport blocks (TB) are scheduled by a single DCI.

Out-of-order of two PDSCHs and the associated PUCCH for HARQ-ACK transmission are not supported in NR. In a given scheduled cell, the UE is not expected to receive a first PDSCH in slot i, with the corresponding HARQ-ACK assigned to be transmitted in slot j, and a second PDSCH starting later than the first PDSCH with its corresponding HARQ-ACK assigned to be transmitted in a slot before slot j. In this IDF, we propose detailed designs on OOO handing considering single-PDSCH or multi-PDSCH scheduling, PUCCH with or without repetition and PUCCH defer.

### OOO Checking for PUCCH Repetition

If PUCCH repetition is configured for a UE, the OOO checking of PDSCHs and the associated PUCCHs for a serving cell can consider the impact of indicated slots and/or available slots for PUCCH repetitions. The slot with the first indicated PUCCH repetition is determined by the last PDSCH scheduled by a DCI and the PDSCH-to-HARQ_feedback timing indicator field (K1) in the DCI. If the first indicated PUCCH repetition is not collided with a SSB symbol or a DL symbol indicated by tdd-UL-DL-ConfigurationCommon or tdd-UL-DL-ConfigurationDedicated, the first indicated PUCCH repetition is the first available PUCCH repetition. Otherwise, the first available PUCCH repetition is delayed to a next available slot.

In one embodiment, OOO checking of PDSCHs and the associated PUCCHs for a serving cell can be defined based on a PDSCH and the indicated first PUCCH repetition for the PDSCH. In a given scheduled cell, the UE is not expected to receive a first PDSCH in slot i, with the corresponding first indicated PUCCH repetition for HARQ-ACK assigned to be transmitted in slot j, and a second PDSCH starting later than the first PDSCH with its corresponding first indicated PUCCH repetition for HARQ-ACK assigned to be transmitted in a slot before slot j.

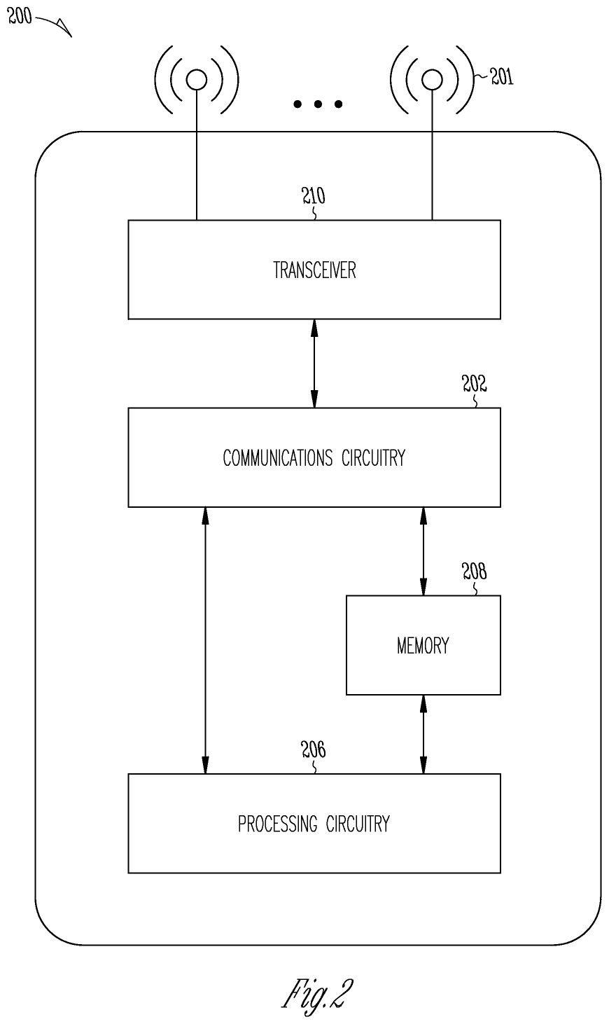

FIG. 4 illustrates one example for OOO checking of two PDSCHs and the associated PUCCHs with repetitions. In the example, the first indicated PUCCH repetition 201 for the PDSCH 1 is collided with a DL symbol, therefore it is delayed to the next available slot 202. The first indicated PUCCH repetition for the PDSCH 2 is the first available PUCCH repetition 203. Note: In FIG. 4, the two available PUCCH repetitions for PDSCH 1 are early than the two available PUCCH repetitions of PDSCH 2. The OOO checking is done by the PDSCH 1, PDSCH 2, the first indicated PUCCH repetition 201 for PDSCH 1 and the first indicated PUCCH repetition 203 for PDSCH 2. Therefore, it is valid scheduling for FIG. 4.

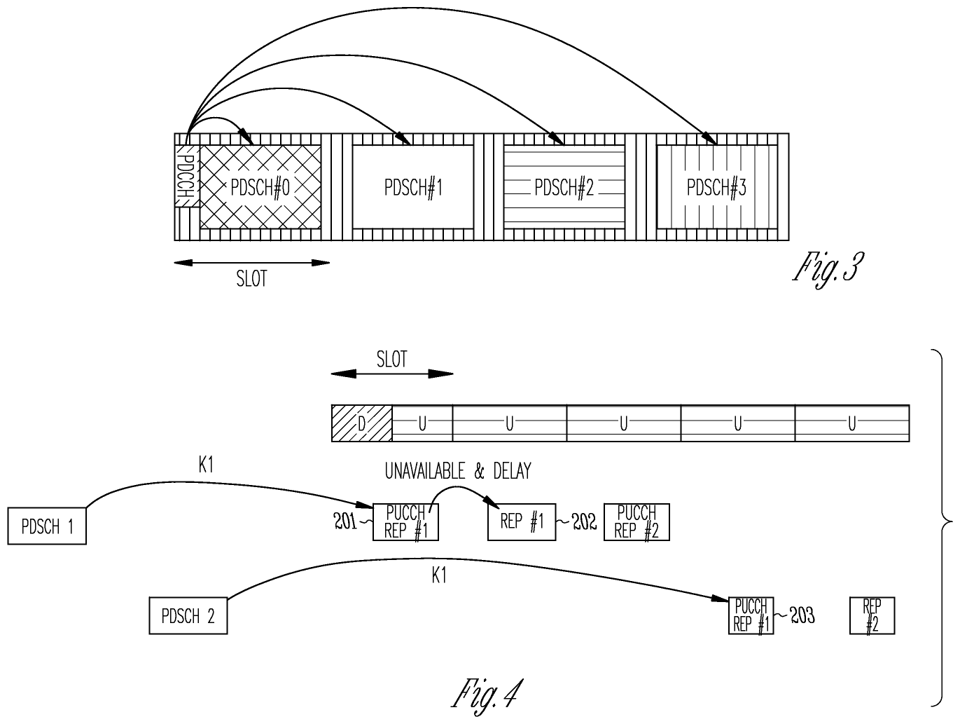

FIG. 5 illustrates another example for OOO checking of two PDSCHs and the associated PUCCHs with repetitions. In the example, the first indicated PUCCH repetition 301 for the PDSCH 1 is collided with a DL symbol, therefore it is delayed to the next available slot 302. The first indicated PUCCH repetition for the PDSCH 2 is the first available PUCCH repetition 303. Note: In FIG. 5, The two available PUCCH repetitions for PDSCH 1 are later than the two available PUCCH repetitions of PDSCH 2. The OOO checking is done by the PDSCH 1, PDSCH 2, the first indicated PUCCH repetition 301 for PDSCH 1 and the first indicated PUCCH repetition 303 for PDSCH 2. Consequently, it is valid scheduling of FIG. 5.

In these embodiments, a UE may be configured to decode a first PDSCH 511 (FIG. 5) and a second PDSCH 513 received from a gNB. In these embodiments, at least the first PDSCH 511 configured for downlink semi-persistent scheduling (SPS). The UE may also generate first HARQ-ACK information bits based on the first PDSCH 511 and second HARQ-ACK information bits based on the second PDSCH 513. In these embodiments, when the UE is configured for deferring HARQ-ACK for the first PDSCH 511 (i.e., the UE is provided with sps-HARQ-Deferral for the first PDSCH 511), the UE may determine, based on first feedback timing K1 provided by the gNB, a first slot 501 for an expected PUCCH transmission with the first HARQ-ACK information bits, assigned for the first PDSCH 511. In some embodiments, when the first slot 501 is unavailable for the expected PUCCH transmission of the first HARQ-ACK information bits (e.g., due to a collision with a downlink symbol), the UE may determine an earliest second slot 502 that is available for a PUCCH transmission that includes the first HARQ-ACK information bits. In these embodiments, the earliest second slot 502 may be the earliest slot that is available for a PUCCH transmission after the first slot 501. In some embodiments, the UE may also determine, based on second feedback timing K1 provided by the gNB, a third slot 503 for an expected PUCCH transmission with the second HARQ-ACK information bits, assigned for the second PDSCH 513. The UE may also verify for the scheduled cell, when the second PDSCH 513 starts later than the first PDSCH 511, that a resource assigned by the second feedback timing k1 for transmission of the second HARQ-ACK information bits does not end before a start of a resource assigned by the first feedback timing k1 for transmission of the first HARQ-ACK information bits.

In these embodiments, in a given scheduled cell, the UE is not expected to receive a first PDSCH 511 and a second PDSCH 513, starting later than the first PDSCH 511, with its corresponding HARQ-ACK assigned to be transmitted on a resource ending before the start of a different resource for the HARQ-ACK assigned to be transmitted for the first PDSCH 511. In these embodiments, the resource assigned by the first feedback timing K1 for transmission of the first HARQ-ACK information bits is always used to verify the order for the first and second HARQ-ACK transmissions even when the first slot is unavailable and the second earliest slot is used for transmission of the first HARQ-ACK information bits.

In some embodiments, when the order of the PUCCH transmissions is invalid (i.e., an out of order transmission), the UE behavior may be unspecified. In some embodiments, when the order of the PUCCH transmissions is invalid, the UE may drop one or both of the PUCCH transmissions, although the scope of the embodiments is not limited in this respect.

In some embodiments, the resource assigned for transmission of the second HARQ-ACK information bits is determined based on the second feedback timing K1 and is within the third slot 503. In these embodiments, the resource assigned for transmission of the first HARQ-ACK information bits is determined based on the first feedback timing k1 and is within the first slot 501.

In some embodiments, when the UE is configured for deferring HARQ-ACK for the first PDSCH 511, the UE may encode the first HARQ-ACK information bits for the PUCCH transmission by the UE in the first slot 501 when the first slot 501 is available for the expected PUCCH transmission of the first HARQ-ACK information bits. In these embodiments, the UE may encode the first HARQ-ACK information bits for the PUCCH transmission by the UE in the earliest second slot 502 when the first slot 501 is unavailable for the expected PUCCH transmission of the first HARQ-ACK information bits. In these embodiments, when the UE is configured with sps-HARQ-Deferral, the UE defers the transmission of the first HARQ-ACK information bits when the first slot was unavailable.

In some embodiments, when the UE is not configured for deferring HARQ-ACK for SPS PDSCH, the UE may encode the first HARQ-ACK information bits for the PUCCH transmission by the UE in the first slot 501 when the first slot 501 is available for the expected PUCCH transmission of the first HARQ-ACK information bits. In these embodiments, the UE may drop the PUCCH transmission of the first HARQ-ACK information bits when the first slot 501 is unavailable for the expected PUCCH transmission of the first HARQ-ACK information bits.

In some embodiments, when the UE is configured for deferring HARQ-ACK for the first PDSCH 511, the UE may encode the first HARQ-ACK information bits for the PUCCH transmission by the UE in the earliest second slot 502 when the first slot 501 is unavailable for the expected PUCCH transmission of the first HARQ-ACK information bits. In these embodiments, the UE may encode the second HARQ-ACK information bits for the PUCCH transmission by the UE in the third slot 503.

In some embodiments, when the earliest second slot 502 is a same slot as the third slot 503, the UE may encode the first HARQ-ACK information bits and the second HARQ-ACK information bits for the PUCCH transmission in the earliest second slot 502.

In some embodiments, when the UE is configured for deferring HARQ-ACK for the first PDSCH 511, the UE may determine that the first slot 501 is unavailable when a PUCCH resource for the expected PUCCH transmission overlaps with a symbol indicated as downlink by tdd-UL-DL-ConfigurationCommon or tdd-UL-DL-ConfigDedicated, and/or overlaps with a synchronization signal/PBCH block (SSB), although the scope of the embodiments is not limited in this respect.

In one embodiment, OOO checking of PDSCHs and the associated PUCCHs for a serving cell can be defined based on a PDSCH and the first available PUCCH repetition for the PDSCH. In a given scheduled cell, the UE is not expected to receive a first PDSCH in slot i, with the corresponding first available PUCCH repetition for HARQ-ACK assigned to be transmitted in slot j, and a second PDSCH starting later than the first PDSCH with its corresponding first available PUCCH repetition for HARQ-ACK assigned to be transmitted in a slot before slot j.

The embodiments illustrated in FIG. 4 can be reused to illustrate an example of the embodiment. The OOO checking is done by the PDSCH 1, PDSCH 2, the first available PUCCH repetition 202 for PDSCH 1 and the first available PUCCH repetition 203 for PDSCH 2. Therefore, it is valid scheduling for FIG. 4.

The embodiments illustrated in FIG. 5 can be reused to illustrate another example of the embodiment. The OOO checking is still done by the PDSCH 1, PDSCH 2, the first available PUCCH repetition 302 for PDSCH 1 and the first available PUCCH repetition 303 for PDSCH 2. Consequently, it is NOT valid scheduling of FIG. 5.

In one embodiment, OOO checking of PDSCHs and the associated PUCCHs for a serving cell can be defined based on a PDSCH and all the available PUCCH repetitions for the PDSCH. In a given scheduled cell, the UE is not expected to receive a first PDSCH in slot i, with a corresponding available PUCCH repetition for HARQ-ACK assigned to be transmitted in slot j, and a second PDSCH starting later than the first PDSCH with a corresponding available PUCCH repetition for HARQ-ACK assigned to be transmitted in a slot before slot j.

The embodiments illustrated in FIG. 5 can be reused to illustrate an example of the embodiment. The OOO checking is done by the PDSCH 1, PDSCH 2, the two available PUCCH repetition (302, 304) for PDSCH 1 and the two available PUCCH repetition (303, 305) for PDSCH 2. Consequently, it is valid scheduling of FIG. 5.

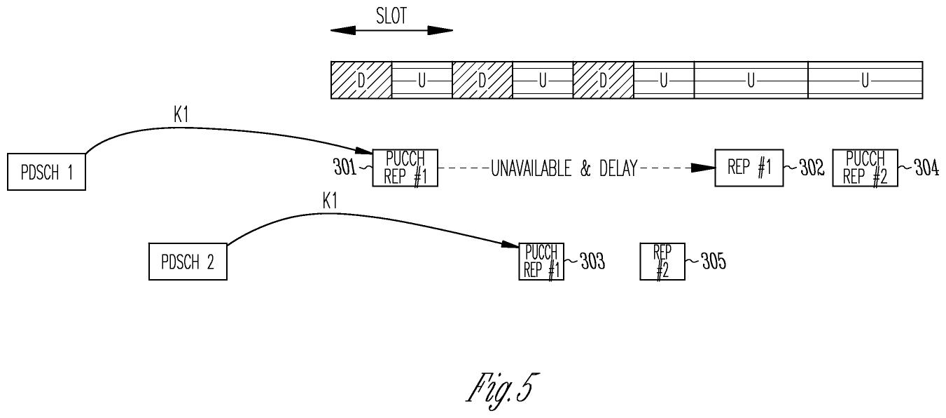

FIG. 6 illustrates another example for 000 checking of two PDSCHs and all associated available PUCCH repetitions for each PDSCH. In the example, a second PUCCH repetition 401 for the PDSCH 1 is collided with a DL symbol, therefore it is delayed to the next available slot 402. Note: In FIG. 6, the second available PUCCH repetition 402 for PDSCH 1 is later than the two available PUCCH repetitions (403, 404) of PDSCH 2. The OOO checking is done by the PDSCH 1, PDSCH 2, the two available PUCCH repetition (400, 402) for PDSCH 1 and the two available PUCCH repetition (403, 404) for PDSCH 2. Consequently, it is NOT valid scheduling of FIG. 6.

In one embodiment, OOO checking of PDSCHs and the associated PUCCHs for a serving cell can be defined based on a PDSCH and the first indicated PUCCH repetition and all the available PUCCH repetitions for the PDSCH. In a given scheduled cell, the UE is not expected to receive a first PDSCH in slot i, with a corresponding PUCCH repetition (including the first indicated PUCCH repetition and any available PUCCH repetition) for HARQ-ACK assigned to be transmitted in slot j, and a second PDSCH starting later than the first PDSCH with a corresponding PUCCH repetition (including the first indicated PUCCH repetition and any available PUCCH repetition) for HARQ-ACK assigned to be transmitted in a slot before slot j.

The embodiments illustrated in FIG. 5 can be reused to illustrate an example of the embodiment. The OOO checking is done by the PDSCH 1, PDSCH 2, the first indicated PUCCH repetition 301 for PDSCH 1, the two available PUCCH repetition (302, 304) for PDSCH 1, the first indicated PUCCH repetition 303 for PDSCH 2 and the two available PUCCH repetition (303, 305) for PDSCH 2. Consequently, it is NOT valid scheduling of FIG. 5.

The embodiments illustrated in FIG. 6 can be reused to illustrate another example of the embodiment. The OOO checking is done by the PDSCH 1, PDSCH 2, the first indicated PUCCH repetition 400 for PDSCH 1, the two available PUCCH repetition (400, 402) for PDSCH 1, the first indicated PUCCH repetition 403 for PDSCH 2, and the two available PUCCH repetition (403, 404) for PDSCH 2. Consequently, it is NOT valid scheduling of FIG. 6.

In one embodiment, OOO checking of PDSCHs and the associated PUCCHs for a serving cell can be defined based on a PDSCH and the first indicated PUCCH repetition and the last available PUCCH repetition for the PDSCH. In a given scheduled cell, the UE is not expected to receive a first PDSCH in slot i, with a corresponding PUCCH repetition (including the first indicated PUCCH repetition and the last available PUCCH repetition) for HARQ-ACK assigned to be transmitted in slot j, and a second PDSCH starting later than the first PDSCH with a corresponding PUCCH repetition (including the first indicated PUCCH repetition and the last available PUCCH repetition) for HARQ-ACK assigned to be transmitted in a slot before slot j. This embodiment can achieve the same OOO checking result as the previous embodiment.

The embodiments illustrated in FIG. 5 can be reused to illustrate an example of the embodiment. The OOO checking is done by the PDSCH 1, PDSCH 2, the first indicated PUCCH repetition 301 for PDSCH 1, the last available PUCCH repetition 304 for PDSCH 1, the first indicated PUCCH repetition 303 for PDSCH 2 and the last available PUCCH repetition 305 for PDSCH 2. Consequently, it is NOT valid scheduling of FIG. 5.

The embodiments illustrated in FIG. 6 can be reused to illustrate another example of the embodiment. The OOO checking is done by the PDSCH 1, PDSCH 2, the first indicated PUCCH repetition 400 for PDSCH 1, the last available PUCCH repetition 402 for PDSCH 1, the first indicated PUCCH repetition 403 for PDSCH 2, and the last available PUCCH repetition 404 for PDSCH 2. Consequently, it is NOT valid scheduling of FIG. 6.

### OOO Checking for PUCCH Defer

If PUCCH defer is configured for a UE, the OOO checking of PDSCHs and the associated PUCCHs for a serving cell can consider the impact of indicated PUCCH slot and/or available slot deferred for PUCCH transmission if applicable. The slot with the indicated PUCCH is determined by the last PDSCH scheduled by a DCI and the PDSCH-to-HARQ_feedback timing indicator field (K1) in the DCI. if the indicated PUCCH is collided with a SSB symbol or a DL symbol indicated by tdd-UL-DL-ConfigurationCommon or tdd-UL-DL-ConfigurationDedicated, the indicated PUCCH is delayed to a next available slot. The PUCCH defer can be applied to PUCCH for SPS PDSCH only case, or applied to any PUCCH, or only applied to PUCCH for PDSCH dynamically scheduled by DCI.

In one embodiment, OOO checking of PDSCHs and the associated PUCCHs for a serving cell can be defined based on a PDSCH and the indicated PUCCH for the PDSCH. In a given scheduled cell, the UE is not expected to receive a first PDSCH in slot i, with the corresponding indicated PUCCH for HARQ-ACK assigned to be transmitted in slot j, and a second PDSCH starting later than the first PDSCH with its corresponding indicated PUCCH for HARQ-ACK assigned to be transmitted in a slot before slot j.

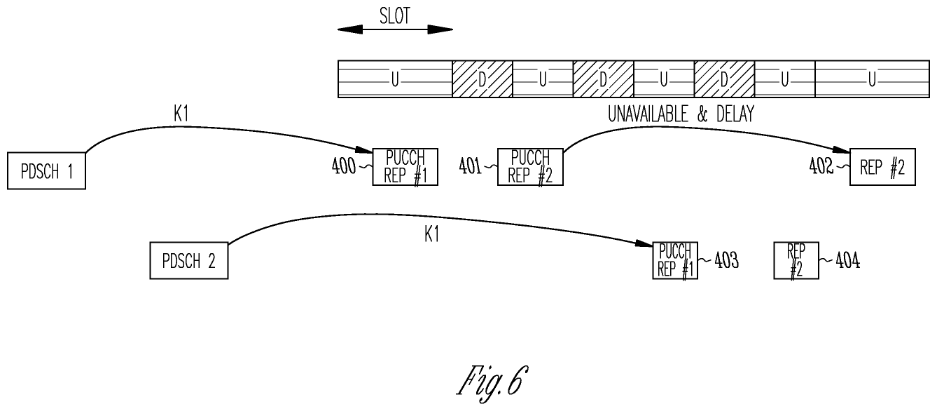

FIG. 7 illustrates one example for OOO checking of two PDSCHs and the associated PUCCHs. In the example, the indicated PUCCH 501 for the PDSCH 1 is collided with a DL symbol, therefore it is delayed to the next available slot, i.e., the deferred PUCCH 502. The indicated PUCCH for the PDSCH 2 is the available PUCCH 503. The OOO checking is done by the PDSCH 1, PDSCH 2, the indicated PUCCH 501 for PDSCH 1 and the indicated PUCCH 503 for PDSCH 2. Therefore, it is valid scheduling for FIG. 7.

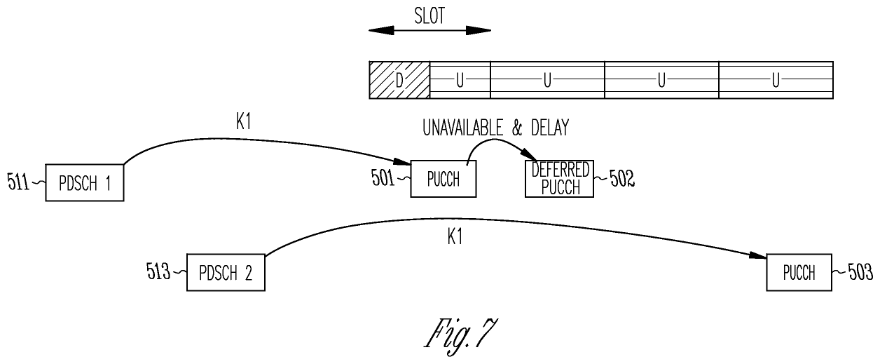

FIG. 8 illustrates another example for OOO checking of two PDSCHs and the associated PUCCHs. In the example, the indicated PUCCH 601 for the PDSCH 1 611 is collided with a DL symbol, therefore it is delayed to the next available slot, i.e., the deferred PUCCH 602. The indicated PUCCH for the PDSCH 2 613 is the available PUCCH 603. The OOO checking is done by the PDSCH 1, PDSCH 2, the indicated PUCCH 601 for PDSCH 1 and the indicated PUCCH 603 for PDSCH 2. Consequently, it is valid scheduling of FIG. 8.

In one embodiment, OOO checking of PDSCHs and the associated PUCCHs for a serving cell can be defined based on a PDSCH and the available PUCCH for the PDSCH. The available PUCCH may be the indicated PUCCH or the deferred PUCCH. In a given scheduled cell, the UE is not expected to receive a first PDSCH in slot i, with the corresponding available PUCCH for HARQ-ACK transmission assigned to be transmitted in slot j, and a second PDSCH starting later than the first PDSCH with its corresponding available PUCCH for HARQ-ACK assigned to be transmitted in a slot before slot j.

The embodiments illustrated in FIG. 7 can be reused to illustrate an example of the embodiment. The OOO checking is done by the PDSCH 1, PDSCH 2, the available PUCCH 502 for PDSCH 1 and the available PUCCH 503 for PDSCH 2. Therefore, it is valid scheduling for FIG. 7.

The embodiments illustrated in FIG. 8 can be reused to illustrate another example of the embodiment. The OOO checking is done by the PDSCH 1, PDSCH 2, the available PUCCH 602 for PDSCH 1 and the available PUCCH 603 for PDSCH 2. Consequently, it is NOT valid scheduling of FIG. 8.

In one embodiment, OOO checking of PDSCHs and the associated PUCCHs for a serving cell can be defined based on a PDSCH and the indicated PUCCH and the deferred PUCCH if applicable for the PDSCH. In a given scheduled cell, the UE is not expected to receive a first PDSCH in slot i, with a corresponding PUCCH (including the indicated PUCCH and the deferred PUCCH if applicable) for HARQ-ACK transmission assigned to be transmitted in slot j, and a second PDSCH starting later than the first PDSCH with a corresponding PUCCH (including the indicated PUCCH and the deferred PUCCH if applicable) for HARQ-ACK assigned to be transmitted in a slot before slot j.

The embodiments illustrated in FIG. 8 can be reused to illustrate an example of the embodiment. The OOO checking is done by the PDSCH 1, PDSCH 2, the indicated PUCCH 601 for PDSCH 1, the deferred PUCCH 602 for PDSCH 1 and the indicated PUCCH 603 for PDSCH 2. Consequently, it is NOT valid scheduling of FIG. 5.
Note that the above embodiments can also apply for the OOO handling for
PDCCH and PDSCH with and without repetitions,
PDCCH and PDSCH with multi-PDSCH scheduling,
PDCCH and PUSCH with and without repetitions, and when PUSCH is counted based on available slots or physical slots.
PDCCH and PUSCH with multi-PUSCH scheduling

In NR Rel-15, when a physical uplink control channel (PUCCH) with single slot transmission overlaps with a PUSCH with single slot transmission, when timeline requirement as defined in Section 9.2.5 in TS38.213 is satisfied, UE would multiplex uplink control information (UCI) on the PUSCH and drop the PUCCH (example 9). Further, when single slot PUCCH overlaps with multi-slot PUSCH repetition in a slot, if the timeline requirement as defined in Section 9.2.5 in TS38.213 is satisfied for the overlapped slot, UE would multiplex UCI on the PUSCH in the overlapped slot and drop the PUCCH.

In Rel-16, in case of missing DL grant, with one PUSCH and no overlapping PUCCH with hybrid automatic repeat request-acknowledgement (HARQ-ACK) within a span of one PUCCH slot for both single carrier and UL carrier aggregation (CA) scenarios, if the uplink-total downlink assignment index (UL-TDAI) is not equal to 4 for Type 2 codebook or equal to 1 for Type 1 codebook, the UE multiplexes HARQ-ACK following the UL-TDAI into the PUSCH.

In one example (example 10) of HARQ-ACK on PUSCH in case of missing DL grant, the UE misses the DL grant and correspondingly, does not know the time domain allocation for PUCCH transmission. In case when UL-TDAI indicated in the UL grant for PUSCH scheduling is not equal to 4 for Type 2 codebook or equal to 1 for Type 1 codebook, UE multiplexes the HARQ-ACK on the PUSCH.

Further, in case of missing DL grant, with multiple overlapping PUSCHs with no overlapping PUCCH with HARQ-ACK within a span of one PUCCH slot, if the UL-TDAI n is not equal to 4 for Type 2 codebook or equal to 1 for Type 1 codebook, it is up to UE implementation how to handle this. Note that when PUSCH repetitions with no overlapping PUCCH with HARQ-ACK within a span of one PUCCH slot, if the UL-TDAI n is not equal to 4 for Type 2 codebook or equal to 1 for Type 1 codebook, certain mechanisms may need to be defined for HARQ-ACK multiplexing on PUSCH repetition.

Embodiments disclosed herein provide systems and methods of HARQ-ACK multiplexing on PUSCH repetitions in case of missing DL grant. We also disclose system and methods of HARQ-ACK and CSI multiplexing on PUSCH in case of missing DL grant.

### HARQ-ACK Multiplexing on PUSCH Repetitions in Case of Missing DL Grant

As mentioned above, in Rel-16, in case of missing DL grant, with one PUSCH and no overlapping PUCCH with hybrid automatic repeat request-acknowledgement (HARQ-ACK) within a span of one PUCCH slot for both single carrier and UL carrier aggregation (CA) scenarios, if the uplink-total downlink assignment index (UL-TDAI) is not equal to 4 for Type 2 codebook or equal to 1 for Type 1 codebook, the UE multiplexes HARQ-ACK following the UL-TDAI into the PUSCH.

Further, in case of missing DL grant, with multiple overlapping PUSCHs with no overlapping PUCCH with HARQ-ACK within a span of one PUCCH slot, if the UL-TDAI n is not equal to 4 for Type 2 codebook or equal to 1 for Type 1 codebook, it is up to UE implementation how to handle this. Note that when PUSCH repetitions with no overlapping PUCCH with HARQ-ACK within a span of one PUCCH slot, if the UL-TDAI n is not equal to 4 for Type 2 codebook or equal to 1 for Type 1 codebook, certain mechanisms may need to be defined for HARQ-ACK multiplexing on PUSCH repetition.

Embodiments of HARQ-ACK multiplexing on PUSCH repetitions in case of missing DL grant are provided as follows:

In one embodiment, with more than one PUSCH repetitions with no overlapping PUCCH with HARQ-ACK within a span of one PUCCH slot, if the UL-TDAI n is not equal to 4 for Type 2 codebook or equal to 1 for Type 1 codebook, the UE multiplexes HARQ-ACK following the UL-TDAI into the first PUSCH repetition in the PUCCH slot. Note that this can be applied for PUSCH repetition type A and PUSCH with transport block processing over multiple slots (TBoMS).

In one example (example 11) of HARQ-ACK on PUSCH repetitions in case of missing DL grant for PUSCH repetition type A, a PUCCH is scheduled on CC #1 with 15 kHz subcarrier spacing (SCS) and PUSCH repetitions are scheduled on CC #0 with 60 kHz SCS. Further, UE misses the DL grant and correspondingly, does not know the time domain allocation for PUCCH transmission. In case when UL-TDAI indicated in the UL grant for PUSCH repetitions is not equal to 4 for Type 2 codebook or equal to 1 for Type 1 codebook, UE multiplexes the HARQ-ACK on the first PUSCH repetition (repetition #0) in the PUCCH slot.

In another embodiment, with more than one PUSCH repetitions with no overlapping PUCCH with HARQ-ACK within a span of one PUCCH slot, if the UL-TDAI n is not equal to 4 for Type 2 codebook or equal to 1 for Type 1 codebook, the UE multiplexes HARQ-ACK following the UL-TDAI into all PUSCH repetitions in the PUCCH slot (Option 2). Alternatively, the UE multiplexes HARQ-ACK following the UL-TDAI into all PUSCH repetitions (Option 3). Note that this can be applied for PUSCH repetition type A and PUSCH with TBoMS.

In one example (example 12) of HARQ-ACK on PUSCH repetitions in case of missing DL grant for PUSCH repetition type A, a PUCCH is scheduled on CC #1 with 15 kHz subcarrier spacing (SCS) and PUSCH repetitions are scheduled on CC #0 with 60 KHz SCS. Further, UE misses the DL grant and correspondingly, does not know the time domain allocation for PUCCH transmission. In case when UL-TDAI indicated in the UL grant for PUSCH repetitions is not equal to 4 for Type 2 codebook or equal to 1 for Type 1 codebook, UE multiplexes the HARQ-ACK on all PUSCH repetitions (repetition #0, #1, #2, #3) in the PUCCH slot.

In another embodiment, for PUSCH repetition type B, with more than one PUSCH repetitions with no overlapping PUCCH with HARQ-ACK within a span of one PUCCH slot, if the UL-TDAI n is not equal to 4 for Type 2 codebook or equal to 1 for Type 1 codebook, the UE multiplexes HARQ-ACK following the UL-TDAI into the first actual PUSCH repetition in the PUCCH slot.

In one example (example 13) of HARQ-ACK on PUSCH repetitions in case of missing DL grant for PUSCH repetition type B, the PUCCH is scheduled on CC #1 with 15 kHz subcarrier spacing (SCS) and PUSCH repetitions are scheduled on CC #0 with 30 kHz SCS. Further, UE misses the DL grant and correspondingly, does not know the time domain allocation for PUCCH transmission. In case when UL-TDAI indicated in the UL grant for PUSCH repetitions is not equal to 4 for Type 2 codebook or equal to 1 for Type 1 codebook, UE multiplexes the HARQ-ACK on the first actual PUSCH repetition (actual repetition #0) in the PUCCH slot.

In another embodiment, for PUSCH repetition type B, with more than one PUSCH repetitions with no overlapping PUCCH with HARQ-ACK within a span of one PUCCH slot, if the UL-TDAI n is not equal to 4 for Type 2 codebook or equal to 1 for Type 1 codebook, the UE multiplexes HARQ-ACK following the UL-TDAI into all PUSCH actual repetitions in the PUCCH slot (Option 2). Alternatively, the UE multiplexes HARQ-ACK following the UL-TDAI into all PUSCH repetitions (Option 3).

In one example (example 14) of HARQ-ACK on PUSCH repetitions in case of missing DL grant for PUSCH repetition type B, the PUCCH is scheduled on CC #1 with 15 kHz subcarrier spacing (SCS) and PUSCH repetitions are scheduled on CC #0 with 30 kHz SCS. Further, UE misses the DL grant and correspondingly, does not know the time domain allocation for PUCCH transmission. In case when UL-TDAI indicated in the UL grant for PUSCH repetitions is not equal to 4 for Type 2 codebook or equal to 1 for Type 1 codebook, UE multiplexes the HARQ-ACK on all actual PUSCH repetitions (repetition #0, #1, #2) in the PUCCH slot.

In another embodiment, if all PUSCH repetitions with no overlapping PUCCH with HARQ-ACK, if the UL-TDAI is not equal to 4 for Type 2 codebook or equal to 1 for Type 1 codebook, the UE multiplexes HARQ-ACK following the UL-TDAI into the first PUSCH repetition (option 1), or the UE multiplexes HARQ-ACK following the UL-TDAI into the first PUSCH repetition in each PUCCH slot (option 2), or the UE multiplexes HARQ-ACK following the UL-TDAI into all PUSCH repetitions (option 3). Otherwise, the UE multiplexes HARQ-ACK in a PUSCH repetition overlapping with a PUCCH with HARQ-ACK following the UL-DAI (Option 4).

In one example (example 15) of HARQ-ACK on PUSCH repetitions in case of missing DL grant for PUSCH repetition type A, the PUCCH is scheduled on CC #1 with 15 kHz subcarrier spacing (SCS) and PUSCH repetitions are scheduled on CC #0 with 30 kHz SCS. Further, UE misses the DL grant for PUCCH1 and correspondingly, does not know the time domain allocation for PUCCH transmission. In case when UL-TDAI indicated in the UL grant for PUSCH repetitions is not equal to 4 for Type 2 codebook or equal to 1 for Type 1 codebook, and UE does not detect any PUCCH overlapping with any PUSCH repetition, UE multiplexes the HARQ-ACK on the first PUSCH repetition (repetition #0) in 1st PUCCH slot.

In one example (example 16) of HARQ-ACK on PUSCH repetitions in case of missing DL grant for PUSCH repetition type A, in case when UL-TDAI indicated in the UL grant for PUSCH repetitions is not equal to 4 for Type 2 codebook or equal to 1 for Type 1 codebook, and UE does not detect PUCCH overlapping with any PUSCH repetition in a PUCCH slot (1st PUCCH slot with PUSCH repetition #0 and #1) while UE detects a PUCCH overlapping with a PUSCH repetition in another PUCCH slot (PUCCH2 overlapping with PUSCH repetition #2), UE does not multiplex HARQ-ACK on PUSCH repetition #0, #1 and #3 while UE multiplexes HARQ-ACK on PUSCH repetition #2 according to UL DAI.

In another embodiment, for a PUSCH transmission with repetitions, if the UL-TDAI n is not equal to 4 for Type 2 codebook or equal to 1 for Type 1 codebook, the UE multiplexes HARQ-ACK following the UL-TDAI into every PUSCH repetition. If a PUSCH repetition does not overlap with any PUCCH with HARQ-ACK, UE multiplexes N bits NACK into the PUSCH repetition according to UL-DAI. If a PUSCH repetition overlaps with a PUCCH with HARQ-ACK, UE multiplexes M bits HARQ-ACK into the PUSCH repetition according to UL-DAI and received PDSCHs associated with the PUCCH. For example, for type-2 HARQ-ACK codebook, M=N+4*i and UL-DAI=N. For another example, for type-1 HARQ-ACK codebook, N=M which is the size of type-1 HARQ-ACK codebook, if n=1.

In one example (example 17) of HARQ-ACK on PUSCH repetitions in case of missing DL grant for PUSCH repetition type A, a PUCCH is scheduled on CC #1 with 15 kHz subcarrier spacing (SCS) and PUSCH repetitions are scheduled on CC #0 with 30 kHz SCS. Further, UE misses the DL grant for PUCCH1 and correspondingly, does not know the time domain allocation for PUCCH transmission. In case when UL-TDAI indicated in the UL grant for PUSCH repetitions is not equal to 4 for Type 2 codebook or equal to 1 for Type 1 codebook, e.g., n=2 for type-2 HARQ-ACK codebook, UE does not detect PUCCH overlapping with PUSCH repetition #0, #1 and #3 while UE detects a PUCCH2 overlapping with PUSCH repetition #2, and UE receives 5 PDSCHs associated with PUCCH 2. UE multiplexes 2 bits NACK into PUSCH repetition #0, #1 and #3 and UE multiplexes 6 bits HARQ-ACK into PUSCH repetition #2.

### HARQ-ACK and CSI Multiplexing on PUSCH in Case of Missing DL Grant

As mentioned above, in Rel-16, in case of missing DL grant, with one PUSCH and no overlapping PUCCH with hybrid automatic repeat request-acknowledgement (HARQ-ACK) within a span of one PUCCH slot for both single carrier and UL carrier aggregation (CA) scenarios, if the uplink-total downlink assignment index (UL-TDAI) is not equal to 4 for Type 2 codebook or equal to 1 for Type 1 codebook, the UE multiplexes HARQ-ACK following the UL-TDAI into the PUSCH.

UE may expect to transmit both HARQ-ACK and CSI in a PUCCH slot. In some scenarios, HARQ-ACK PUCCH resource overlaps with CSI PUCCH resource, UE multiplexes HARQ-ACK and CSI in one resultant PUCCH, and then, UE multiplex the resultant PUCCH on a PUSCH. In some scenarios, HARQ-ACK PUCCH resource does not overlap with CSI PUCCH resource, UE multiplexes HARQ-ACK PUCCH and CSI PUCCH on a PUSCH respectively. The PUSCH selected for HARQ-ACK and the PUSCH selected for CSI may be the same or different PUSCH, according to PUSCH selection rule defined in Rel-15/16.

In case of missing DL grant for HARQ-ACK, UE behavior for CSI transmission is unclear. FIG. 10 illustrates one example. HARQ-ACK PUCCH overlaps with PUSCH 1 and PUSCH 2, and CSI PUCCH overlaps with PUSCH 2, HARQ-ACK PUCCH does not overlap with CSI PUCCH in Case 1. On the other hand, HARQ-ACK PUCCH does overlap with CSI PUCCH in Case 2. If UE miss-detects DL grant for HARQ-ACK, it is unclear how UE transmits CSI, e.g., if the UL-TDAI n is not equal to 4 for Type 2 codebook or equal to 1 for Type 1 codebook for both PUSCH 1 and PUSCH 2 but UE fails to detect HARQ-ACK PUCCH, UE does not know whether to multiplex CSI in PUSCH 1 or PUSCH 2 or drop CSI.

In one embodiment, for a PUSCH with no overlapping PUCCH with HARQ-ACK but there is PUCCH with CSI within a span of one PUCCH slot, if the UL-TDAI n is not equal to 4 for Type 2 codebook or equal to 1 for Type 1 codebook, the UE multiplexes HARQ-ACK following the UL-TDAI into one or multiple PUSCHs according to pre-defined rule, and the UE multiplexes CSI with the HARQ-ACK in the same PUSCH(s). In these examples (examples 18 and 19), if PUSCH 1 is selected to multiplex HARQ-ACK, CSI is also multiplexed with HARQ-ACK in PUSCH 1, no matter the CSI PUCCH overlaps with PUSCH 1 or not.

In another embodiment, for a PUSCH with no overlapping PUCCH with HARQ-ACK but there is PUCCH with CSI within a span of one PUCCH slot, if the UL-TDAI n is not equal to 4 for Type 2 codebook or equal to 1 for Type 1 codebook, the UE multiplexes HARQ-ACK following the UL-TDAI into one or multiple PUSCHs according to pre-defined rule, and the UE drops CSI. In these examples (examples 18 and 19), CSI is dropped for all cases.

In another embodiment, for a PUSCH with no overlapping PUCCH with HARQ-ACK but there is PUCCH with CSI within a span of one PUCCH slot, if the UL-TDAI n is not equal to 4 for Type 2 codebook or equal to 1 for Type 1 codebook, the UE multiplexes HARQ-ACK following the UL-TDAI into one or multiple PUSCHs according to pre-defined rule, and the UE multiplexes CSI with the HARQ-ACK in the same PUSCH(s), if CSI PUCCH resource overlaps with the PUSCH for HARQ-ACK multiplexing.

In one option, if the CSI PUCCH resource does not overlap with the PUSCH for HARQ-ACK multiplexing, UE selects a PUSCH for CSI according to Rel-15/16 rule, if any.

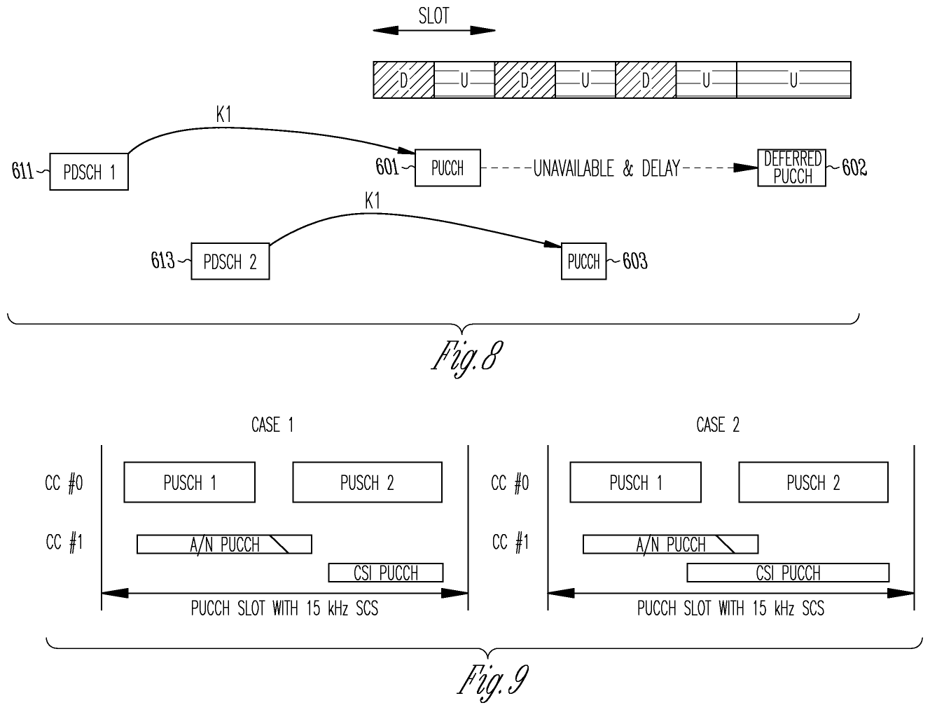

FIG. 9 illustrates HARQ-ACK and CSI on PUSCH in case of missing DL grant for PUSCH, in accordance with some embodiments. In FIG. 9 (example 18), for case 1, UE multiplexes HARQ-ACK in PUSCH 1 and UE multiplexes CSI in PUSCH 2. For case 2, UE multiplexes HARQ-ACK and CSI in PUSCH 1. In example 19, for case 3, UE multiplexes HARQ-ACK in PUSCH 1 and UE transmits CSI PUCCH. For case 4, UE multiplexes HARQ-ACK in PUSCH 1 and UE multiplexes CSI in PUSCH 2.

In another option, if the CSI PUCCH resource does not overlap with the PUSCH for HARQ-ACK multiplexing, UE drops the CSI. For case 1 & case 3 & case 4, UE multiplexes HARQ-ACK in PUSCH 1 and drop CSI. For case 2, UE multiplexes HARQ-ACK and CSI in PUSCH 1.

In another embodiment, for a PUSCH with no overlapping PUCCH with HARQ-ACK but there is PUCCH with CSI within a span of one PUCCH slot, if the UL-TDAI n is not equal to 4 for Type 2 codebook or equal to 1 for Type 1 codebook, the UE multiplexes HARQ-ACK following the UL-TDAI into one or multiple PUSCHs according to pre-defined rule, and the UE multiplexes CSI in a PUSCH according to Rel-15/16 rule.

In another embodiment, for a PUSCH with no overlapping PUCCH with HARQ-ACK but there is PUCCH with CSI within a span of one PUCCH slot, if the UL-TDAI n is not equal to 4 for Type 2 codebook or equal to 1 for Type 1 codebook, the UE multiplexes HARQ-ACK following the UL-TDAI into one or multiple PUSCHs according to pre-defined rule, and the UE selects a PUSCH for CSI according to Rel-15/16 and the UL-TDAI value.

In one option, if the PUSCH for CSI selected according to Rel-15/16 rule is a PUSCH with UL-DAI n equal to 4 for Type 2 codebook or equal to 0 for Type 1 codebook, the UE multiplexes CSI in the PUSCH, otherwise, UE multiplexes HARQ-ACK and CSI in the same PUSCH for HARQ-ACK, or, UE drops CSI.

In another option, if the PUSCH for CSI selected according to Rel-15/16 rule is a PUSCH with UL-DAI n not equal to 4 for Type 2 codebook or equal to 1 for Type 1 codebook, the UE multiplexes CSI in the PUSCH, otherwise, UE multiplexes HARQ-ACK and CSI in the same PUSCH for HARQ-ACK, or UE drops CSI.

In another option, the PUSCH for CSI is selected from the PUSCH with UL-TDAI n not equal to 4 for Type 2 codebook or equal to 1 for Type 1 codebook, if any, and then Rel-15/16 PUSCH selection rule is applied. If there is no PUSCH with UL-TDAI n not equal to 4 for Type 2 codebook or equal to 1 for Type 1 codebook overlapping with CSI PUCCH, the UE multiplexes HARQ-ACK and CSI in the same PUSCH for HARQ-ACK. Alternatively, if there is no PUSCH with UL-TDAI n not equal to 4 for Type 2 codebook or equal to 1 for Type 1 codebook overlapping with CSI PUCCH, the UE drops CSI.

In above embodiments, if a UE is configured with multiple PUCCH resources in a slot to transmit CSI in a PUCCH slot, UE determines CSI multiplexing for each CSI PUCCH resource respectively. Alternatively, UE joint determines CSI multiplexing for all CSI PUCCH resources. Alternatively, UE only determines CSI multiplexing for one CSI PUCCH resource and drops other CSI reports.

For example, for a PUSCH with no overlapping PUCCH with HARQ-ACK but there is one CSI PUCCH within a span of one PUCCH slot, UE determines CSI multiplexing according to one of above embodiments. For a PUSCH with no overlapping PUCCH with HARQ-ACK but there is more than one CSI PUCCH within a span of one PUCCH slot, if the UL-TDAI n is not equal to 4 for Type 2 codebook or equal to 1 for Type 1 codebook, the UE multiplexes HARQ-ACK following the UL-TDAI into one or multiple PUSCHs according to pre-defined rule, and UE drops all CSIs. Alternatively, if more than one CSI PUCCH overlaps with a PUSCH with UL-TDAI n is not equal to 4 for Type 2 codebook or equal to 1 for Type 1 codebook, all the CSIs are multiplexed in the same PUSCH.

### HARQ-ACK Multiplexing on PUSCH in Case of Missing DL Grant

As mentioned above, in case of missing DL grant, with one or more PUSCHs and no overlapping PUCCH with HARQ-ACK within a span of one PUCCH slot for both single carrier and UL carrier aggregation (CA) scenarios, if the uplink—total downlink assignment index (UL-TDAI) is not equal to 4 for Type 2 codebook or equal to 1 for Type 1 codebook, certain mechanisms may need to be defined for HARQ-ACK multiplexing on PUSCH.

In case of different SCS for PUCCH cell and other cells, the slot duration may be different for different cells. For example, if SCS for PUCCH cell is 30 KHz while SCS for another cell with PUSCH is 15 KHz, a PUSCH may overlap with 2 PUCCH slot. Moreover, PUCCH slot can be slot or sub-slot. In case of PUCCH resource configured with sub-slot, the PUCCH slot duration can be shorter than a slot for PUSCH. For example, if SCS for all cells are 15 KHz, PUCCH is configured with 2-symbol sub-slot, a PUSCH may overlap with up to 7 sub-slots. If one PUCCH slot overlaps with more than one PUSCH and at least one of the PUSCH crosses the PUCCH slot, UE behavior for HARQ-ACK multiplexing on PUSCH in case of missing DL grant is unclear.

In one embodiment, for a PUCCH slot without PUCCH with HARQ-ACK, if at least one PUSCH overlapping with the PUCCH slot is with UL-TDAI n not equal to 4 for Type 2 codebook or equal to 1 for Type 1 codebook, UE determines candidate PUSCHs for HARQ-ACK multiplexing, wherein the candidate PUSCHs are all PUSCHs overlapping with the PUCCH slot or a sub-set of all PUSCHs overlapping with the PUCCH slot, e.g., the PUSCHs with UL-TDAI n not equal to 4 for Type 2 codebook or equal to 1 for Type 1 codebook. UE selects one PUSCH from candidate PUSCHs and multiplexes HARQ-ACK onto the PUSCH following the UL-TDAI for the PUSCH. If UE identifies more than one PUCCH with HARQ-ACK would be multiplexed in the same PUSCH, UE considers it as error case, or UE behavior is unspecified. Note that the PUSCH for HARQ-ACK multiplexing may be the first PUSCH or last PUSCH from the candidate PUSCHs.

In some examples (examples 20A and 20B) of a PUSCH across two sub-slots for PUCCH with HARQ-ACK in case of missing DL grant, assuming UE receives DL grant for PUCCH2, the UE multiplexes PUCCH2 with PUSCH 2 according to existing UCI multiplexing procedure (example 20A). UE does not receive DL grant for PUCCH1, but UE receives UL grant for PUSCH 1 with UL TDAI=2. UE expects a PUCCH with HARQ-ACK in sub-slot #0 though UE miss-detects the DL grant. In this case, UE determines PUSCH 1 as candidate PUSCH for sub-slot 0 and multiplex HARQ-ACK of PUCCH1 in sub-slot 0 onto PUSCH 1. In example 20B, assuming UE receives DL grant for PUCCH1 so UE multiplexes PUCCH1 with PUSCH 1 according to existing UCI multiplexing procedure. UE does not receive DL grant for PUCCH2, but UE receives UL grant for PUSCH 2 with UL TDAI=2. Since PUSCH 2 is within sub-slot #1, UE expects a PUCCH with HARQ-ACK in sub-slot #1 though UE miss-detects the DL grant. In this case, UE determines PUSCH 1 and PUSCH 2 as candidate PUSCHs for sub-slot 1. If UE selects PUSCH 1 for HARQ-ACK multiplexing, e.g., 1^{st} PUSCH overlapping with the sub-slot 1. But multiplexing two PUCCHs with HARQ-ACK into one PUSCH is not supported (at least when intra-UE multiplexing between different priorities is not configured), UE considers it as error case.

In another embodiment, for a PUCCH slot without PUCCH with HARQ-ACK, if at least one PUSCH overlapping with the PUCCH slot is with UL-TDAI n not equal to 4 for Type 2 codebook or equal to 1 for Type 1 codebook, UE determines candidate PUSCHs for HARQ-ACK multiplexing, wherein the candidate PUSCHs are all PUSCHs overlapping with the PUCCH slot or a sub-set of all PUSCHs overlapping with the PUCCH slot, e.g., the PUSCHs with UL-TDAI n not equal to 4 for Type 2 codebook or equal to 1 for Type 1 codebook. UE selects one PUSCH from candidate PUSCHs for HARQ-ACK multiplexing. Note that the PUSCH for HARQ-ACK multiplexing may be the first PUSCH or last PUSCH from the candidate PUSCHs. If UE identifies more than one PUCCH with HARQ-ACK would be multiplexed in the same PUSCH, UE only multiplexes HARQ-ACK from one PUCCH onto the PUSCH following the UL-TDAI for the PUSCH. For example, if UE receives DL grant for one PUCCH with HARQ-ACK, UE multiplexes the PUCCH onto the PUSCH. For another example, if UE does not receive any DL grant for any PUCCH with HARQ-ACK, UE multiplexes one PUCCH onto the PUSCH, with all NACKs.

In one example (example 21) of a PUSCH across two sub-slots for PUCCH with HARQ-ACK in case of missing DL grant, assuming the UE receives DL grant for PUCCH1, the UE multiplexes HARQ-ACK from PUCCH1 with PUSCH 1 according to existing UCI multiplexing procedure. UE does not receive DL grant for PUCCH2. UE determines PUSCH 1 and PUSCH 2 as candidate PUSCHs for sub-slot 1 and UE selects PUSCH 1 for HARQ-ACK multiplexing, e.g., 1^{st} PUSCH overlapping with the sub-slot 1. On the other hand, UE determines PUSCH 1 and PUSCH 2 as candidate PUSCHs for sub-slot 2 too. However, multiplexing two PUCCHs with HARQ-ACK into one PUSCH is not supported (at least when intra-UE multiplexing between different priorities is not configured), thus UE does not multiplex PUCCH2 with any PUSCH.

In another embodiment, for a PUCCH slot without PUCCH carrying HARQ-ACK, if at least one PUSCH overlapping with the PUCCH slot is with UL-TDAI n not equal to 4 for Type 2 codebook or equal to 1 for Type 1 codebook, UE determines candidate PUSCHs for HARQ-ACK multiplexing, wherein a PUSCH which is already determined to multiplex a HARQ-ACK feedback for a previous PUCCH slot is excluded from candidate PUSCHs for the PUCCH slot.

For examples 20B and 21, since PUSCH 1 is already chosen to multiplex with PUCCH1, PUSCH 1 is excluded from candidate PUSCHs for sub-slot 1. Therefore, UE multiplexes HARQ-ACK for sub-slot 1 on PUSCH 2.

In another embodiment, for a PUCCH slot without PUCCH with HARQ-ACK, if at least one PUSCH confined within the PUCCH slot is with UL-TDAI n not equal to 4 for Type 2 codebook or equal to 1 for Type 1 codebook, UE determines candidate PUSCHs for HARQ-ACK multiplexing, wherein a PUSCH not confined within the PUCCH slot is excluded from candidate PUSCHs for the PUCCH slot, and UE selects one PUSCH from candidate PUSCHs and multiplexes HARQ-ACK onto the PUSCH following the UL-TDAI, otherwise, UE does not multiplex HARQ-ACK in a PUSCH, or UE behavior is not specified. Note that the PUSCH for HARQ-ACK multiplexing may be the first PUSCH or last PUSCH from the candidate PUSCHs.

For example 20B, for sub-slot1, PUSCH 2 with UL-TDAI=2 is confined with the sub-slot 1. So, UE can identify a PUCCH in sub-slot 1 though UE does not receive any DL grant for PUCCH2. UE multiplexes PUCCH2 with PUSCH 2. For example 21, there is no PUSCH confined within the sub-slot 1. UE may not identify whether there is any PUCCH in sub-slot 1. UE does not multiplex PUCCH with PUSCH for sub-slot 1.

In one embodiment, if a UE is configured with more than one priority, e.g., configured with LP and HP PUCCH resource, UE determines whether DL grant is missing for a PUCCH with HARQ-ACK by checking UL TDAI for PUSCH with a priority respectively.

In example 21, a PUCCH slot, both HP PUSCH 1 and LP PUSCH 2 overlap with the PUCCH slot. Since the UE is configured with both LP and HP PUCCH resource, gNB may schedule a PUCCH with HARQ-ACK for LP and a PUCCH with HARQ-ACK for HP respectively within same PUCCH slot, if both LP and HP is configured with slot for PUCCH resource. UE does not receive any DL grant for LP HARQ-ACK, but UE receives UL grant for LP PUSCH 2 with UL TDAI=2, therefore UE identifies a missed PUCCH for LP HARQ-ACK, and UE selects LP PUSCH 2 to multiplex LP HARQ-ACK.

In above embodiments, for a PUSCH not overlapping with any PUCCH while HARQ-ACK is piggybacked into the PUSCH according to UL DAI, UE generates N bits NACK according to the UL DAI value n.

In above embodiments, different options can be applied for different HARQ-ACK codebook type. In above embodiments, different options can be applied for different PUSCH repetition type, e.g., Type-A or Type-B repetition, PUSCH with transport block processing over multiple slots (TBoMS) and multi-PUSCH scheduling by single DCI. In case of multi-PUSCH scheduling by single DCI, a PUSCH repetition discussed above is replaced with a PUSCH transmission. Note that for the above embodiments, UE is expected that the timeline for UCI multiplexing on PUSCH as defined in Section 9.2.5 in TS38.213 is satisfied. Further, the above embodiments can be applied for single carrier and CA scenarios.

In some embodiments, when a UE is scheduled by a gNB for transmission of multiple PUSCHs on respective serving cells and the multiple PUSCHs overlap with a PUCCH carrying uplink control information (UCI) in a slot, the UE may select the PUSCHs that are overlapping with the PUCCH carrying the UCI as candidate PUSCHs for UCI multiplexing in the slot. In these embodiments, when at least one of the multiple PUSCHs is scheduled by a DCI format that includes a downlink assignment index (DAI) field, for HARQ-ACK multiplexing, the UE may be configured to exclude one or more of the candidate PUSCHs for HARQ-ACK multiplexing that are scheduled by a DCI format that includes a DAI field that is equal to four or equal to zero when no PUCCH carrying HARQ-ACK information bits is determined for the slot. In these embodiments, the UE may select one or more of the remaining candidate PUSCHs that have not been excluded for HARQ-ACK multiplexing.

In these embodiments, when no PUCCH carrying HARQ-ACK information bits is determined by the UE for the slot, it may be because the UE may have mis-detected a PDCCH that scheduled a PDSCH. Accordingly, no HARQ-ACK information bits are generated since the UE did not receive the scheduled PDSCH. In these embodiments, the UE understands that no HARQ-ACK is multiplexed on the PUSCH with a UL-DAI=4 since the UE did not receive a corresponding PDSCH.

In these embodiments, one of the remaining candidate PUSCHs are selected for HARQ-ACK multiplexing even though no PUCCH carrying HARQ-ACK information bits is determined for the slot. In these embodiments, the PUSCH data may be rate matched around UCIs in the PUSCH. To avoid the impact of an incorrect UCI payload caused by a miss-detected PDCCH for PDSCH associated with HARQ-ACK, UE may transmit dummy bits as the HARQ-ACK information bits in the place of UCI part in PUSCH and perform rate match of data part around UCI part in PUSCH. This may help ensures the correct data part in PUSCH.

In some embodiments, the UE may be configured to refrain from excluding the candidate PUSCHs that are scheduled by a DCI format that includes a DAI field that is equal to four or equal to zero when a PUCCH carrying HARQ-ACK information bits is determined for the slot.

In some embodiments, to exclude the one or more of the candidate PUSCHs for the HARQ-ACK multiplexing that are scheduled by a DCI format that includes a DAI field that is equal to four or equal to zero when no PUCCH carrying HARQ-ACK information bits is determined for the slot, the UE may exclude any one or more of the candidate PUSCHs that are scheduled by a DCI format that includes a DAI field that is equal to four when the UE is configured with a dynamic pdsch-HARQ-ACK-Codebook. In these embodiments, the UE may also exclude any one or more of the candidate PUSCHs that are scheduled by a DCI format that includes a DAI field that is equal to zero when the UE is configured with a semi-static pdsch-HARQ-ACK-Codebook.

In some embodiments, the UCI may include HARQ-ACK information bits and channel state information (CSI). In these embodiments, for multiplexing the CSI, the UE may refrain from excluding candidate PUSCHs that are scheduled by a DCI format that includes a DAI field that is equal to four or zero. In some embodiments, the PUCCH carrying the CSI may be a different PUCCH than the PUCCH that is carrying the HARQ-ACK information bits, although the scope of the embodiments is not limited in this respect. In these embodiments, the PUCCH carrying the CSI and the PUCCH that is carrying the HARQ-ACK information bits may both be transmitted in the same slot.

In some embodiments, when more than one of the candidate PUSCHs have been scheduled by dynamic grant (DG) (DG PUSCH), the UE may select one of the DG PUSCHs with an smallest serving cell index. In these embodiments, when more than one of the DG PUSCHs have a smallest serving cell index, the UE may select one of the DG PUSCHs that is earliest in the slot.

In some embodiments, when none of the one of the candidate PUSCHs have been scheduled by dynamic grant and at least one of the candidate PUSCHs have been scheduled by a configured grant (CG) (CG PUSCH), the UE may select one of the CG PUSCHs with an smallest serving cell index. In these embodiments, more than one of the CG PUSCHs may have a smallest serving cell index. In these embodiments, the UE may select one of the CG PUSCHs that is earliest in the slot. In some of these embodiments, UE may first check whether there is CG PUSCH or DG PUSCH scheduled. if there is DG PUSCH scheduled, then, UE chooses the DG PUSCH. If more than one DG PUSCH is scheduled, UE chooses the DG PUSCH with smallest serving cell index. If there is no DG PUSCH scheduled while there are multiple CG PUSCHs, UE chooses a CG PUSCH with smallest serving cell index. If more than one PUSCH with smallest serving cell index, the UE chooses earliest PUSCH in the slot.

### EXAMPLES

1. Example 1: A system and method of wireless communication for out-of-order handling on the PDSCH and the associated PUCCH for HARQ-ACK transmission:

2. The method of example 1, if PUCCH repetition is configured for a UE, the OOO checking of PDSCHs and the associated PUCCHs for a serving cell refers to the indicated slots and/or available slots for PUCCH repetitions.

3. The method of example 2, the OOO checking is defined based on a PDSCH and the indicated first PUCCH repetition for the PDSCH

4. The method of example 2, the OOO checking is defined based on a PDSCH and the first available PUCCH repetition for the PDSCH.

5. The method of example 2, the OOO checking is defined based on a PDSCH and all the available PUCCH repetitions for the PDSCH.

6. The method of example 2, the OOO checking is defined based on a PDSCH and the first indicated PUCCH repetition and all the available PUCCH repetitions for the PDSCH.

7. The method of example 2, the OOO checking is defined based on a PDSCH and the first indicated PUCCH repetition and the last available PUCCH repetition for the PDSCH.

8. The method of example 1, if PUCCH defer is configured for a UE, the OOO checking of PDSCHs and the associated PUCCHs for a serving cell refers to the indicated PUCCH slot and/or available slot deferred for PUCCH transmission if applicable.

9. The method of example 2, based on a PDSCH and the indicated PUCCH for the PDSCH.

10. The method of example 2, based on a PDSCH and the available PUCCH for the PDSCH.

11. The method of example 2, based on a PDSCH and the indicated PUCCH and the deferred PUCCH if applicable for the PDSCH.

### Additional Examples

1. Example 1A: A system and method of wireless communication for a fifth generation (5G) or new radio (NR) system: Determined, by UE, one or more physical uplink shared channel (PUSCH) repetitions with no overlapping physical uplink control channel (PUCCH) with hybrid automatic repeat request-acknowledgement (HARQ-ACK) within a span of one PUCCH slot; and Multiplexed, by UE, the HARQ-ACK feedback on the determined one or more PUSCH repetitions.

2. The method of example 1A, wherein with more than one PUSCH repetitions with no overlapping PUCCH with HARQ-ACK within a span of one PUCCH slot, if the UL-TDAI n is not equal to 4 for Type 2 codebook or equal to 1 for Type 1 codebook, the UE multiplexes HARQ-ACK following the UL-TDAI into the first PUSCH repetition in the PUCCH slot.

3. The method of example 1A, wherein with more than one PUSCH repetitions with no overlapping PUCCH with HARQ-ACK within a span of one PUCCH slot, if the UL-TDAI n is not equal to 4 for Type 2 codebook or equal to 1 for Type 1 codebook, the UE multiplexes HARQ-ACK following the UL-TDAI into all PUSCH repetitions in the PUCCH slot.

4. The method of example 1A, wherein with more than one PUSCH repetitions with no overlapping PUCCH with HARQ-ACK within a span of one PUCCH slot, if the UL-TDAI n is not equal to 4 for Type 2 codebook or equal to 1 for Type 1 codebook, the UE multiplexes HARQ-ACK following the UL-TDAI into all PUSCH repetitions.

5. The method of example 1A, wherein the PUSCH repetitions are for PUSCH repetition type A and PUSCH with TBOMS.

6. The method of example 1A, wherein for PUSCH repetition type B, with more than one PUSCH repetitions with no overlapping PUCCH with HARQ-ACK within a span of one PUCCH slot, if the UL-TDAI n is not equal to 4 for Type 2 codebook or equal to 1 for Type 1 codebook, the UE multiplexes HARQ-ACK following the UL-TDAI into the first actual PUSCH repetition in the PUCCH slot.

7. The method of example 1A, wherein for PUSCH repetition type B, with more than one PUSCH repetitions with no overlapping PUCCH with HARQ-ACK within a span of one PUCCH slot, if the UL-TDAI n is not equal to 4 for Type 2 codebook or equal to 1 for Type 1 codebook, the UE multiplexes HARQ-ACK following the UL-TDAI into all PUSCH actual repetitions in the PUCCH slot.

8. The method of example 1A, wherein for PUSCH repetition type B, with more than one PUSCH repetitions with no overlapping PUCCH with HARQ-ACK within a span of one PUCCH slot, if the UL-TDAI n is not equal to 4 for Type 2 codebook or equal to 1 for Type 1 codebook, the UE multiplexes HARQ-ACK following the UL-TDAI into all PUSCH actual repetitions.

9. The method of example 1A, wherein if all PUSCH repetitions with no overlapping PUCCH with HARQ-ACK, if the UL-TDAI is not equal to 4 for Type 2 codebook or equal to 1 for Type 1 codebook, the UE multiplexes HARQ-ACK following the UL-TDAI into the first PUSCH repetition (option 1), or the UE multiplexes HARQ-ACK following the UL-TDAI into the first PUSCH repetition in each PUCCH slot (option 2), or the UE multiplexes HARQ-ACK following the UL-TDAI into all PUSCH repetitions (option 3). Otherwise, the UE multiplexes HARQ-ACK in a PUSCH repetition overlapping with a PUCCH with HARQ-ACK following the UL-DAI (Option 4).

10. The method of example 1A, wherein for a PUSCH transmission with repetitions, if the UL-TDAI n is not equal to 4 for Type 2 codebook or equal to 1 for Type 1 codebook, the UE multiplexes HARQ-ACK following the UL-TDAI into every PUSCH repetition. If a PUSCH repetition does not overlap with any PUCCH with HARQ-ACK, UE multiplexes N bits NACK into the PUSCH repetition according to UL-DAI

11. The method of example 1A, wherein for a PUSCH not overlapping with any PUCCH while HARQ-ACK is piggybacked into the PUSCH according to UL DAI, UE generates N bits NACK according to the UL DAI value n.

12. The method of example 1A, wherein the timeline for UCI multiplexing on PUSCH is satisfied

13. The method of example 1A, wherein the above embodiments can be applied for single carrier and carrier aggregation (CA) scenarios.

14. The method of example 1A, wherein for a PUSCH with no overlapping PUCCH with HARQ-ACK but there is PUCCH with CSI within a span of one PUCCH slot, if the UL-TDAI n is not equal to 4 for Type 2 codebook or equal to 1 for Type 1 codebook, the UE multiplexes HARQ-ACK following the UL-TDAI into one or multiple PUSCHs according to pre-defined rule, and the UE multiplexes CSI with the HARQ-ACK in the same PUSCH(s).

15. The method of example 1A, wherein for a PUSCH with no overlapping PUCCH with HARQ-ACK but there is PUCCH with CSI within a span of one PUCCH slot, if the UL-TDAI n is not equal to 4 for Type 2 codebook or equal to 1 for Type 1 codebook, the UE multiplexes HARQ-ACK following the UL-TDAI into one or multiple PUSCHs according to pre-defined rule, and the UE drops CSI

16. The method of example 1A, wherein for a PUSCH with no overlapping PUCCH with HARQ-ACK but there is PUCCH with CSI within a span of one PUCCH slot, if the UL-TDAI n is not equal to 4 for Type 2 codebook or equal to 1 for Type 1 codebook, the UE multiplexes HARQ-ACK following the UL-TDAI into one or multiple PUSCHs according to pre-defined rule, and the UE multiplexes CSI with the HARQ-ACK in the same PUSCH(s), if CSI PUCCH resource overlaps with the PUSCH for HARQ-ACK multiplexing.

17. The method of example 1A, wherein for a PUSCH with no overlapping PUCCH with HARQ-ACK but there is PUCCH with CSI within a span of one PUCCH slot, if the UL-TDAI n is not equal to 4 for Type 2 codebook or equal to 1 for Type 1 codebook, the UE multiplexes HARQ-ACK following the UL-TDAI into one or multiple PUSCHs according to pre-defined rule, and the UE multiplexes CSI in a PUSCH according to Rel-15/16 rule.

18. The method of example 1A, wherein for a PUSCH with no overlapping PUCCH with HARQ-ACK but there is PUCCH with CSI within a span of one PUCCH slot, if the UL-TDAI n is not equal to 4 for Type 2 codebook or equal to 1 for Type 1 codebook, the UE multiplexes HARQ-ACK following the UL-TDAI into one or multiple PUSCHs according to pre-defined rule, and the UE selects a PUSCH for CSI according to Rel-15/16 and the UL-TDAI value.

The Abstract is provided to comply with 37 C.F.R. Section 1.72 (b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1-20. (canceled)

21. An apparatus of a user equipment (UE) configured for operation in a fifth-generation (5G) new radio (NR) network, the apparatus comprising: processing circuitry; and memory, wherein the processing circuitry is configured to:
decode a first physical downlink shared channel (PDSCH) received from a generation Node B (gNB), the first PDSCH configured for downlink semi-persistent scheduling (SPS);
generate first hybrid automatic repeat request acknowledge (HARQ-ACK) information bits based on SPS PDSCH receptions of the first PDSCH;
when the UE is configured for deferring the HARQ-ACK information bits for the SPS PDSCH receptions of the first PDSCH (SPS HARQ-Deferral), the processing circuitry is configured to:
determine a physical uplink control channel (PUCCH) resource in a first slot for an expected PUCCH transmission of the first HARQ-ACK information bits for the SPS PDSCH receptions that the UE would report for a first time;
determine a PUCCH resource in an earliest second slot, after the first slot, that is available for a PUCCH transmission when the PUCCH resource in the first slot overlaps with a symbol indicated as downlink; and
multiplex HARQ-ACK information bits for transmission in the PUCCH resource determined for the earliest second slot,
wherein the multiplexed HARQ-ACK information bits include deferred HARQ-ACK information bits from the first HARQ-ACK information bits from to the SPS PDSCH receptions of the first PDSCH, and
wherein the deferred HARQ-ACK information bits for the second slot are multiplexed when a deferral time is less than a maximum number of slots or sub-slots between the PUCCH transmission in the second slot and the SPS PDSCH receptions in a prior slot, and
wherein the memory is configured to store the first HARQ-ACK information bits.

22. The apparatus of claim 21, wherein when the UE is configured for SPS HARQ-Deferral for the first PDSCH, the processing circuitry is configured to determine that the first slot is unavailable when the PUCCH resource in the first slot for the expected PUCCH transmission overlaps with a symbol indicated as downlink by tdd-UL-DL-ConfigurationCommon or tdd-UL-DL-ConfigDedicated.

23. The apparatus of claim 22, wherein when the UE is configured for SPS HARQ-Deferral for the first PDSCH, the processing circuitry is further configured to determine that the first slot is unavailable when the PUCCH resource in the first slot for the expected PUCCH transmission overlaps with a symbol indicated for a synchronization signal/physical broadcast channel (PBCH) block (SSB).

24. The apparatus of claim 23, wherein the processing circuitry is configured to decode signalling received from the gNB comprising an sps-HARQ-Deferral information element to configure the UE for deferring the HARQ-ACK information bits for the SPS PDSCH receptions of the first PDSCH.

25. The apparatus of claim 24, wherein signalling includes a maximum number of slots for deferring the HARQ-ACK information bits for the SPS PDSCH receptions of the first PDSCH.

26. The apparatus of claim 25, wherein the processing circuitry is configured to refrain from multiplexing the HARQ-ACK information bits from the first HARQ-ACK information bits when the deferral time is not less than a maximum number of slots or sub-slots between the PUCCH transmission in the second slot and the SPS PDSCH receptions in the prior slot.

27. The apparatus of claim 25, wherein the processing circuitry is further configured to:
decode a second PDSCH received from the gNB;
generate second HARQ-ACK information bits based receptions of the second PDSCH;
multiplex the second HARQ-ACK information bits for transmission in the PUCCH resource determined for the earliest second slot.

28. The apparatus of claim 27, wherein the processing circuitry is configured to multiplex the second HARQ-ACK information bits for transmission in the PUCCH resource determined for the earliest second slot when the first and second PDSCHs are scheduled by a same downlink control information (DCI).

29. The apparatus of claim 23, wherein the deferred HARQ-ACK information bits for the second slot are multiplexed when a deferral time is less than a time difference between the PUCCH transmission in the second slot and the SPS PDSCH receptions in a prior slot.

30. The apparatus of claim 21, wherein when the UE is scheduled by the gNB for transmission of multiple PUSCHs on respective serving cells and the multiple PUSCHs overlap with a PUCCH carrying uplink control information (UCI) in a slot, the processing circuitry is configured to:
select the PUSCHs that are overlapping with the PUCCH carrying the UCI as candidate PUSCHs for UCI multiplexing in the slot;
when at least one of the multiple PUSCHs is scheduled by a DCI format that includes a downlink assignment index (DAI) field for HARQ-ACK multiplexing, the processing circuitry is configured to:
exclude one or more of the candidate PUSCHs for HARQ-ACK multiplexing that are scheduled by a DCI format that includes a DAI field that is equal to four; and
select one or more of the candidate PUSCHs that have not been excluded for HARQ-ACK multiplexing.

31. A computer-readable storage medium that stores instructions for execution by processing circuitry a user equipment (UE) configured for operation in a fifth-generation (5G) new radio (NR) network, the processing circuitry is configured to:
decode a first physical downlink shared channel (PDSCH) received from a generation Node B (gNB), the first PDSCH configured for downlink semi-persistent scheduling (SPS);
generate first hybrid automatic repeat request acknowledge (HARQ-ACK) information bits based on SPS PDSCH receptions of the first PDSCH;
when the UE is configured for deferring the HARQ-ACK information bits for the SPS PDSCH receptions of the first PDSCH (SPS HARQ-Deferral), the processing circuitry is configured to:
determine a physical uplink control channel (PUCCH) resource in a first slot for an expected PUCCH transmission of the first HARQ-ACK information bits for the SPS PDSCH receptions that the UE would report for a first time;
determine a PUCCH resource in an earliest second slot, after the first slot, that is available for a PUCCH transmission when the PUCCH resource in the first slot overlaps with a symbol indicated as downlink; and
multiplex HARQ-ACK information bits for transmission in the PUCCH resource determined for the earliest second slot,
wherein the multiplexed HARQ-ACK information bits include deferred HARQ-ACK information bits from the first HARQ-ACK information bits from to the SPS PDSCH receptions of the first PDSCH, and
wherein the deferred HARQ-ACK information bits for the second slot are multiplexed when a deferral time is less than a maximum number of slots or sub-slots between the PUCCH transmission in the second slot and the SPS PDSCH receptions in a prior slot.

32. The computer-readable storage medium of claim 31, wherein when the UE is configured for SPS HARQ-Deferral for the first PDSCH, the processing circuitry is configured to determine that the first slot is unavailable when the PUCCH resource in the first slot for the expected PUCCH transmission overlaps with a symbol indicated as downlink by tdd-UL-DL-ConfigurationCommon or tdd-UL-DL-ConfigDedicated.

33. The computer-readable storage medium of claim 32, wherein when the UE is configured for SPS HARQ-Deferral for the first PDSCH, the processing circuitry is further configured to determine that the first slot is unavailable when the PUCCH resource in the first slot for the expected PUCCH transmission overlaps with a symbol indicated for a synchronization signal/physical broadcast channel (PBCH) block (SSB).

34. The computer-readable storage medium of claim 33, wherein the processing circuitry is configured to decode signalling received from the gNB comprising an sps-HARQ-Deferral information element to configure the UE for deferring the HARQ-ACK information bits for the SPS PDSCH receptions of the first PDSCH.

35. The computer-readable storage medium of claim 34, wherein signalling includes a maximum number of slots for deferring the HARQ-ACK information bits for the SPS PDSCH receptions of the first PDSCH.

36. The computer-readable storage medium of claim 35, wherein the processing circuitry is configured to refrain from multiplexing the HARQ-ACK information bits from the first HARQ-ACK information bits when the deferral time is not less than a maximum number of slots or sub-slots between the PUCCH transmission in the second slot and the SPS PDSCH receptions in the prior slot.

37. The computer-readable storage medium of claim 35, wherein the processing circuitry is further configured to:
decode a second PDSCH received from the gNB;
generate second HARQ-ACK information bits based receptions of the second PDSCH;
multiplex the second HARQ-ACK information bits for transmission in the PUCCH resource determined for the earliest second slot.

38. An apparatus of a generation Node B (gNB) configured for operation in a fifth-generation (5G) new radio (NR) network, the apparatus comprising: processing circuitry; and
memory, wherein the processing circuitry is configured to:
encode a first physical downlink shared channel (PDSCH) for transmission to a user equipment (UE), the first PDSCH configured for downlink semi-persistent scheduling (SPS);
when the UE is configured for deferring hybrid automatic repeat request acknowledge (HARQ-ACK) information bits for the SPS PDSCH receptions of the first PDSCH (SPS HARQ-Deferral), the processing circuitry is configured to:
determine a physical uplink control channel (PUCCH) resource in a first slot for an expected PUCCH transmission of first HARQ-ACK information bits for the SPS PDSCH receptions that the UE would report for a first time, the first HARQ-ACK information bits generated by the UE based on SPS PDSCH receptions of the first PDSCH;
determine a PUCCH resource in an earliest second slot, after the first slot, that is available for a PUCCH transmission when the PUCCH resource in the first slot overlaps with a symbol indicated as downlink; and
decode a transmission comprising multiplexed HARQ-ACK information bits received in the PUCCH resource determined for the earliest second slot,
wherein the multiplexed HARQ-ACK information bits include deferred HARQ-ACK information bits from the first HARQ-ACK information bits from to the SPS PDSCH receptions of the first PDSCH, and
wherein the deferred HARQ-ACK information bits for the second slot are multiplexed when a deferral time is less than a maximum number of slots or sub-slots between the PUCCH transmission in the second slot and the SPS PDSCH receptions in a prior slot, and
wherein the memory is configured to store the first HARQ-ACK information bits.

39. The apparatus of claim 38, wherein when the UE is configured for SPS HARQ-Deferral for the first PDSCH, the first slot is unavailable when the PUCCH resource in the first slot for the expected PUCCH transmission overlaps with a symbol indicated as downlink by tdd-UL-DL-ConfigurationCommon or tdd-UL-DL-ConfigDedicated.

40. The apparatus of claim 22, wherein when the UE is configured for SPS HARQ-Deferral for the first PDSCH, the first slot is unavailable when the PUCCH resource in the first slot for the expected PUCCH transmission overlaps with a symbol indicated for a synchronization signal/physical broadcast channel (PBCH) block (SSB).
